(19) United States
(12) Patent Application Publication
(10) Pub. No.: US 2005/0222286 A1
(43) Pub. Date: Oct. 6, 2005

(54) Combustion modified polyurethane foam

(76) Inventors: Stephen D. Gilder, Collierville, TN (US); William Griggs, Southhaven, MS (US); Joe Progar, Carol Stream, IL (US); Tommy Fish, Mooreville, NC (US); Eugenio Ferrer, W. Chicago, IL (US)

Correspondence Address: CONLEY ROSE, P.C., 5700 GRANITE PARKWAY, SUITE 330, PLANO, TX, 75024, US

(21) Appl. No.: 10/505,472

(22) PCT Filed: Mar. 12, 2003
(86) PCT No.: PCT/US03/08110

§ 371 Date: Aug. 20, 2004

Related U.S. Application Data
(60) Provisional application No. 60/364,654, filed on Mar. 14, 2002.
(60) Provisional application No. 60/364,660, filed on Mar. 14, 2002.

(51) Int. Cl. C08K 3/00

(52) U.S. Cl. 521/128

(57) ABSTRACT

Disclosed is a polyurethane foam comprising less than about 10 weight percent melamine and less than about 10 weight percent of one or more additional flame retardant compounds, both based on the total weight of the foam. In an embodiment, the weight ratio of melamine to the additional flame retardant compounds is in the range of from about 0.5 to about 2.0. The foam is a reaction product of one or more polyols, one or more isocyanates, one or more blowing agents, and one or more catalysts. In an embodiment, the foam has a density of within the range of from about 0.9 to about 4.25 lb/ft3, a 25% IFD in the range of from about 7 to about 150 lb/50 in2, and an air flow in the range of about 2.0 to about 5.5 ft3/minute. In an embodiment, the melamine is ground melamine.

### CROSS-REFERENCE TO RELATED APPLICATIONS

The present application claims benefit of priority from U.S. Provisional Application Ser. No. 60/364,654 filed Mar. 14, 2002, entitled “Combustion Modified Polyurethane Foam” and U.S. Provisional Application Ser. No. 60/364,660 filed Mar. 14, 2002, entitled “Method and System for Making Combustion Modified Polyurethane Foam,” both of which are incorporated herein by reference in their entirety.

### FIELD OF THE INVENTION

The present invention relates to incorporation of melamine into flexible polyurethane foam as a flame retardant compound, and more specifically incorporation of melamine into flexible polyurethane foam formed by the reaction of a polyol, isocyanate, and water, with or without using an auxiliary-blowing agent.

### BACKGROUND

Polyurethane foam is currently utilized by many industries such as furniture, construction, transportation, insulation, medical, and packaging. Flexible polyurethane foam was first introduced to furniture manufacturers in the late 1950's and quickly replaced the use of the more expensively produced latex foam rubber. It is capable of creating a firm yet comfortable and durable product that is easily shaped into desired forms. Flexible polyurethane foam has now become the most commonly used cushioning material in upholstered furnishings, mattresses, and airline and automobile seating.

Like all other organic materials, polyurethane foam products will ignite when exposed to a sufficient heat source and therefore stringent legal standards for flame retardancy of polyurethane foam products have been established. Flame-retardant additives are commonly incorporated into the polyurethane foam polymers to meet these requirements. Due to the physical properties of melamine it is sometimes used as a flame-retardant additive in urethane foams.

Typically, flexible polyurethane foam is manufactured in slab stock form in what is often referred to as a “one shot” process. The process involves the continuous pouring of mixed liquids such as a polyol and isocyanate onto a conveyor where it reacts into a froth creating a continuous loaf of foam. Water or other chemical additives can be used as blowing agents that turn into gas bubbles upon reaction, quickly expanding the froth to form a large “bun” or “slab” of partially polymerized polyurethane foam. Once the foam is fully expanded, the polymerization progresses in seconds to reach a fully cross-linked, solid state. The continuous slab is then cut, allowed to cool or “cure”, and stored. Methods to manufacture flame-retardant polyurethane foams are well known to one skilled in the art, however, resultant foam product quality remains a function of the chemical composition and manufacturing procedures, and both are continually reviewed for improvements to the final product.

### SUMMARY OF THE INVENTION

Disclosed herein is a polyurethane foam comprising less than about 10 weight percent melamine and less than about 10 weight percent of one or more additional flame retardant compounds, both based on the total weight of the foam. In an embodiment, the weight ratio of melamine to the additional flame retardant compounds is in the range of from about 0.5 to about 2.0. The foam is a reaction product of one or more polyols, one or more isocyanates, one or more blowing agents, and one or more catalysts and passes the California T.B.117 burn test. In an embodiment, the reaction product comprises about 100 parts per hundred of the polyol. In an embodiment, the foam has a density of within the range of from about 0.9 to about 4.25 lb/ft³, a 25% IFD in the range of from about 7 to about 150 lb/50 in², and an air flow in the range of about 2.0 to about 5.5 ft³/minute. In an embodiment, the melamine is ground melamine, for example with a minimum particle size of about 0.83 microns, a maximum particle size of about 74 microns, a mean particle size of about 12.28 microns, a purity of about 99.8 weight percent pure, a moisture content of about 0.05 weight percent, and a pH of about 8.1, and a volume average particle size distribution of 100%<=about 74 microns, 75%<=about 19.25 microns, 50%<=about 12.28 microns, 25%<=about 6.84 microns, 0%<=about 0.83 microns.

Also disclosed is a slab stock process for making a polyurethane foam comprising adding less than about 10 weight percent melamine based on the total weight of the foam and less than about 10 weight percent of one or more additional flame retardant compounds based on the total weight of the foam. In an embodiment, ground melamine is pre-blended with a polyol in a weight ratio conducive to homogeneous mixing, typically 1:1 polyol to melamine, under high shear via an in-line shear pump. In an embodiment, the pre-blend is recirculated through the shear pump for a minimum of about 2 hours at about 300 lbs/hr flow rate and temperature of about 21° C.

Additionally, a carbon dioxide frothing process is disclosed for making a polyurethane foam composition comprising adding less than about 10 weight percent melamine based on the total weight of the foam and less than about 10 weight percent of one or more additional flame retardant compounds based on the total weight of the foam. In an embodiment, ground melamine is pre-blended with a polyol in a weight ratio conducive to homogeneous mixing, typically 1:1 polyol to melamine, under high shear via an in-line shear pump. In an embodiment, the pre-blend is recirculated through the shear pump for a minimum of about 2 hours at about 300 lbs/hr flow rate and temperature of about 21° C. In an embodiment, the pre-blend is filtered both prior to entry into a mixing head as well as after exiting the mixing head. In an embodiment, the filter upstream of the mixing head has a hole size of about 300 microns and the filter downstream of the mixing head has a hole size about less than or equal to the width of the discharge slot on a gate bar for laying down the foam composition.

### BRIEF DESCRIPTION OF THE DRAWINGS

FIG. 1 is a particle size distribution graph for a ground melamine.

FIG. 2 is a process flow diagram of a high shear blending unit.

FIGS. 3A and 3B are diagrams of a shear pump.

FIG. 4 is a process flow diagram of a slab stock polyurethane foam production line.

FIG. 5 is a diagram of various metal troughs.

FIG. 6 is a carbon dioxide frothing process flow diagram of a polyurethane foam production line.

### DETAILED DESCRIPTION OF THE PREFERRED EMBODIMENTS

The present disclosure includes a flexible, flame retardant polyurethane foam comprising low amounts of melamine and a second flame retardant compound. As used herein, flame retardant means that the foam at a minimum be capable of passing the California 117 Burn Test (California TB-117). Typically, the foam is a reaction product of a polyol, an isocyanate, a blowing agent, melamine, a second flame retardant compound, catalyst, and optionally other additives. In an embodiment, the melamine comprises less than about 10 weight percent of the weight of the total foam composition, desirably less than about 8.5 weight percent, and more desirably in the range of from about 5 to about 6 weight percent. The second flame retardant compound comprises less than about 10 weight percent of the total foam composition, desirably less than about 8 weight percent, and more desirably less than about 6 weight percent. The weight ratio of melamine to the second flame retardant compound (melamine/second flame retardant) is in the range of from about 0.5 to about 2.0, desirably in the range of from about 0.6 to about 1.5, and more desirably about 0.75 to about 1.25. In an embodiment, the weight ratio of melamine to the second flame retardant compound is about 1.0. Typically, the total foam composition comprises about 100 parts per hundred (pph) by weight of one or more polyols.

The flexible combustion modified polyurethane foam formulations of this disclosure are suitable for either the more commonly used conventional foams of varying hardness grades (as defined by the indentation force deflection (IFD) of the foam) or the more expensive high resiliency (HR) foams used in high-performance products. Conventional foams typically range in densities from about 1.0 lb/ft³ to about 4.5 lb/ft³ with a 25% IFD in the range of from about 8 to about 150 lb/50 in². HR foams typically range in densities from about 1.75 lb/ft³ to about 4.0 lb/ft³ with a 25% IFD in the range of from about 9 to about 70 lb/50 in². Additionally, HR foams typically have a ball rebound of greater than about 50% and a support factor of greater than about 2.4, both of these specifications per ASTM D3574. In an embodiment, the foam of this disclosure has a density of in the range of from about 0.9 to about 4.25 lb/ft³, a 25% IFD in the range of from about 7 to about 150 lb/50 in², and an air flow in the range of about 2.0 to about 5.5 ft³/minute. In another embodiment, the foam has a density of in the range of from about 0.9 to about 1.5 lb/ft³, a 25% IFD in the range of from about 7 to about 54 lb/50 in², and an air flow in the range of about 4.0 to about 5.5 ft³/minute. In another embodiment, the foam has a density of in the range of from about 1.6 to about 4.25 lb/ft³, a 25% IFD in the range of from about 11 to about 150 lb/50 in², and an air flow in the range of about 2.0 to about 4.0 ft³/minute.

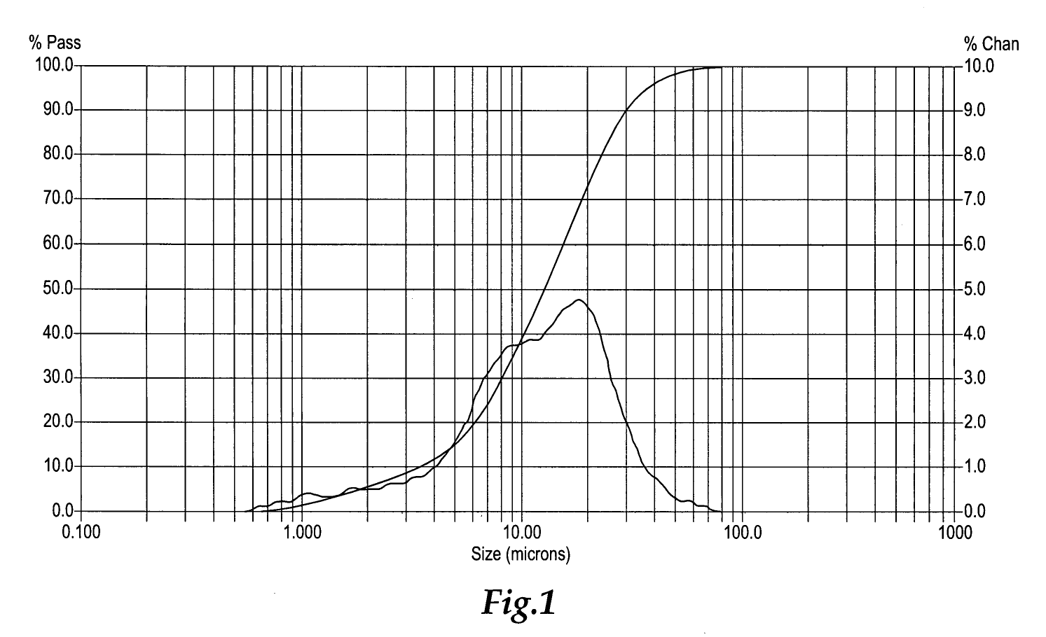

Melamine is derived from urea, which comes from carbon dioxide and ammonia. The melamine of this disclosure is preferably of a type commonly referred to as ground melamine wherein the melamine undergoes a grinding process (typically at an offsite melamine supplier's facility) to reduce the particle size prior to blending. In an embodiment, the ground melamine incorporated into the foams generally has a mean particle size of about 28 microns or less. In another embodiment, the melamine has a minimum particle size of about 0.83 microns, a maximum particle size of about 74 microns, a mean particle size of about 12.28 microns, a purity of about 99.8 weight percent pure, a moisture content of about 0.05 weight percent, and a pH of about 8.1, and a volume average particle size distribution of 100%<=about 74 microns, 75%<=about 19.25 microns, 50%<=about 12.28 microns, 25%<=about 6.84 microns, 0%<=about 0.83 microns. An example of a suitable melamine is Flame-Amine 200 available from U.S. Chemicals, Inc., specifications for which are included in Table 1A below. FIG. 1 depicts a graph of the particle size distribution for Flame-Amine 200 and shows a mean volume average particle size of about 14.51 microns. In another embodiment, an example of a suitable melamine is BTL Melamine available from BTLSR Toledo, Inc., specifications for which are included in Tables 1B and 1C below that show the particle distribution in both weight percent distribution as well as count distribution.

TABLE 1A

| Flame-Amine 200 (Melamine Fine Grind) | Specifications |
|---|---|
| Melamine | 99.8% |
| Moisture | 0.05% |
| Alkali Solubles | 0.002% |
| Ash | 10 ppm |
| Iron | 1 ppm |
| pH | 8.1 |
| Particle Size: Through 200 mesh | 99% |
| Particle Size: Through 325 mesh | 96% |

TABLE 1B
BTL Melamine-Weight Percent Distribution

| Size Micron | Tyler Mesh | Melamine Unground | Melamine Ground |
|---|---|---|---|
| 295 | 50 | 0 | 0 |
| 177 | 80 | 2 | 0 |
| 74 | 200 | 30 | 0.5 |
| 44 | 325 | 56 | 20 |
| 20 | | 75 | 50 |
| 10 | | 90 | 75 |

TABLE 1C
BTL Melamine-Count Distribution

| Size Micron | Melamine Unground | Melamine Ground |
|---|---|---|
| >124 | 0-5 | 0 |
| 30-124 | 10-30 | 8-20 |
| 8-30 | 30-40 | 30-40 |
| <8 | 8-20 | 30-50 |
| mean | 15-27 | 8-20 |

The second flame retardant compound may be any suitable flame retardant compound that provides the synergistic combination with ground melamine, and is desirably a liquid at processing conditions. Examples of suitable second flame retardant compounds include DE-60F Special and Firemaster 550, both available from Great Lakes Chemical Corporation, specification sheets for which are included in Tables 2 and 3 below. Firemaster 550 is a low viscosity liquid flame retardant. Its high efficiency as a flame retardant is a result of phosphorus-bromine synergy. It does not contain brominated diphenyl ethers. An example of a suitable second flame retardant compound that is typically used in HR foams is Antiblaze 195 (AB 195) available from Rhodia Chemicals, specification sheet for which is included in Table 3A below. Antiblaze 195 is a neutral chloroalkyl phosphate ester with excellent thermal and hydrolytic stability. This water insoluble additive flame retardant is compatible with a broad range of polymeric systems and provides durable flame retardancy. It is recommended for use in both polyether and polyester based polyurethane foams and other resin systems. In an embodiment, the second flame retardant that is combined with melamine does not contain a dicyanodiamide, oxamide, or biuret. Optionally, in an alternate embodiment, the second flame retardant could be comprised of the second flame retardant and an additional (third) flame retardant.

TABLE 2
DE-60F Special-Halogenated Flame Retardant
Typical Properties

| Blend | Pentabromodiphenyl Oxide Blend |
|---|---|
| Appearance | Amber Liquid (per GM7602) |
| Bromine Content, % | 51.0-53.5 (per QCS8711) |
| Acidity, mg KOH/g | 0.25 max. (per QCS8329) |
| Volatiles, 1 hr @ 105° C., % | 0.20 max. (per QCS8328) |
| Specific Gravity @25° C., g/ml | 1.9 |

Viscosity

| | | | | |
|---|---|---|---|---|
| Temperature, ° C. | 10 | 20 | 40 | 50 |
| Viscosity, cps | 34,400 | 4,470 | 312 | 62 |

Thermogravimetric Analysis (10 mg @ 10° C./minute under N2)

| | | | | |
|---|---|---|---|---|
| Weight Loss, % | 5 | 10 | 50 | 95 |
| Temperature, ° C. | 209 | 225 | 267 | 291 |

Solubility (g/100 g Solvent)

| | | | |
|---|---|---|---|
| Water | <0.1 | Toluene | Complete |
| Methylene Chloride | Complete | Methyl Ethyl Ketone | Complete |
| Methanol | 6 | | |

TABLE 3
Firemaster ® 550-Phosphorus Bromine Flame Retardant
Typical Properties

| Appearance | Clear Amber Liquid |
|---|---|
| Bromine Content, % | 27.1 |
| Phosphorous Content, % | 4.3 |

| | | | | |
|---|---|---|---|---|
| Temperature, ° C. | 10 | 20 | 30 | 40 |
| Viscosity, cps | 420 | 177 | 83 | 47 |

Thermogravimetric Analysis (10 mg @ 10° C./minute under N2)

| | | | | |
|---|---|---|---|---|
| Weight Loss, % | 5 | 10 | 50 | 95 |
| Temperature, ° C. | 208 | 221 | 263 | 292 |

Solubility (g/100 g Solvent)

| | | | |
|---|---|---|---|
| Water | <0.1 | Toluene | Complete |
| Methylene Chloride | Complete | Methyl Ethyl Ketone | Complete |
| Methanol | 5.7 | | |

TABLE 3A
ANTIBLAZE 195-Tris (dichloro-propyl) phosphate
Typical Properties

| | |
|---|---|
| Phosphorus | 7.2% |
| Chlorides | 49.1% |
| Appearance | liquid |
| Acid Number | 0.1 mg KOH/gm |
| Specific Gravity | 1.513 at 25° C. |

The polyol may be any suitable polyol for use in a reaction to form polyurethane foam and may be a conventional polyol, a grafted polyol, or combinations thereof. In an embodiment, the polyol is a polyether polyol or combinations thereof. Examples of suitable polyols include Pluracol 2100 and Pluracol 2130, both available from BASF Corporation, and Voranol 3136 and Voranol 3943A, available from Dow Chemical Company, specification information for which are included below in Tables 4-6. Pluracol polyol 2100 is a primary terminated conventional triol and contains a LVI inhibitor package. Pluracol polyol 2130 is a primary hydroxyl-terminated graft poyether triol containing approximately 31% solids of copolymerized styrene and acrylonitrile, utiwzing a LVI inhibitor package. Voranol 3136 polyether polyol is a general purpose, nominal 3100 molecular weight, heteropolymer triol. Voranol 3943A copolymer polyol is a grafted polyol containing high levels of copolymerized styrene and acrylonitrile. It forms stable dispersions that will not separate under normal conditions.

Examples of other suitable polyols include Pluracol 994 and Pluracol 1385 by BASF Corporation, Voranol CP3322 and Voranol 3010 by Dow Chemical Company, Arcol 1131, Arcol 3020, and Arcol 3010 by Bayer Chemicals, and Caradol SC46-02 and Caradol SC56-02 by Shell Chemicals, and any other like polyols. In an embodiment, polyols known as Voranol 3943A, Voranol HL-400, and Voranol HL-430, all by Dow Chemical Company, (or any other polyol medium containing an acrylonitrile/styrene graft polymer dispersed therein) are not used as the sole polyol component in the foam formulation. In other words, for this embodiment when using a polyol having an acrylonitrile/styrene graft polymer dispersed therein, a second polyol that does not contain acrylonitrile/styrene graft polymer is combined therewith to form a polyol mixture.

TABLE 4

| | Pluracol ® 2100 | Pluracol ® 2130 |
|---|---|---|
| Hydroxyl number, | 24.0-26.0 | 23.0-26.0 |
| mg KOH/gm | (per STI 3007/3162) | (per STI 3145) |
| Water, weight % | 0.05 | 0.05 |
| maximum | (per STI 3062) | (per STI 3062) |
| Acid number, | 0.015 | 0.015 |
| maximum | (per STI 3063/3161) | (per STI 3134) |
| Nominal functionality | 3 | 3 |
| Nominal molecular | 6500 | |
| weight | | |
| Density | 8.49 lbs/gal @ 77° F. | 1.006 gm/cm³@77° F. |
| | 8.40 lbs/gal @ 100° F. | 1.000 gm/cm³@86° F. |
| | 8.25 lbs/gal @ 140° F. | 0.997 gm/cm³@95° F. |
| Viscosity, CPS | 1370 @ 77° F. | 3250 @77° F. |
| | 790 @ 100° F. | 2470 @86° F. |
| | 375 @ 140° F. | 1890 @95° F. |
| Specific heat, | 0.5 | 0.5 |
| BTU/lb ° F. | | |
| Thermal conductivity, | 0.087 | 0.087 |
| BTU/hr ft² ° F./in | | |
| Appearance | Clear liquid | Creamy, opaque liquid |

TABLE 5
Voranol 3136

| | |
|---|---|
| Hydroxyl number | 52.0-57.0 mg KOH/gm |
| Water, weight % maximum | 0.08 |
| APHA color, max | 35 |
| Viscosity, cSt | 230-255 @100° F. |
| Typical Properties | |
| Antioxidant Package | BHT-Free |
| Density | 8.482 lbs/gal @ 77° F. |
| | 1.016 gm/cm³@25° C. |
| Specific Gravity | 1.019 gm/cc, 25/25° C. |
| Flash Point (PMCC) | 445° F./230° C. |
| Viscosity, cSt | 3400 @ 32° F. |
| | 464 @ 77° F. |
| | 245 @ 100° F. |
| | 38 @ 210° F. |
| Specific heat, cal/gm° C. | 0.441 @40° C. |
| | 0.454 @60° C. |
| | 0.478 @100° C. |
| Thermal conductivity, | 0.00035 @35° C. |
| gm cal/cm sec ° C. | |
| | 0.000344 @65° C. |
| | 0.000337 @95° C. |
| Refractive Index, 25° C. | 1.4530 |
| Vapor Pressure, mm Hg | <0.01 @25° C. |

TABLE 6
Voranol 3943A

| | |
|---|---|
| Hydroxyl number | 24.1-29.7 mg KOH/gm |
| Hydroxyl, % | 0.73-0.90 |
| Solids, % | 41.5-44.5 |
| Water, weight % maximum | 0.08 |
| Typical Properties | |
| Hydroxyl number | 27 |
| Solids, % | 43 |
| Density | 8.72 lbs/gal @ 25° C. |
| Specific Gravity | 1.046 gm/cc, 25/25° C. |
| Viscosity, cSt (Cannon-Fenske) | 5300 @ 77° F. (25° C.) |
| | 774 @ 150° F. (65.5° C.) |
| | 295 @ 210° F. (98.9° C.) |
| Flash point, ° F. (PMCC, ASTM D93) | 335 |
| Appearance | White, opaque, viscous liquid |

The isocyanate may be any suitable isocyanate for use in a reaction to form polyurethane foam, and in an embodiment the isocyanate is toluene diisocyanate (TDI). Preferably, the TDI comprises an isomeric blend of 80/20 weight ratio or a 65/35 weight: ratio of 2,4 isomer/2,6 isomer. Examples of suitable 80/20 TDI blends are Lupranate T80 available from BASF Corporation and Voranate T-80 available from Dow Chemical, specification sheets for which are included in Tables 7-10 below. Lupranate® T80 toluene diisocyanate (TDI) is an 80/20 mixture of the 2,4 and 2,6 isomers of toluene diisocyanate. Examples of other suitable isocyanates include methylene diphenyl isocyanate (NOI) and MDI/TDI blends.

TABLE 7
Lupranate ® T80 (Toluene Diisocyanate)

| | | | Method |
|---|---|---|---|
| Specification Limits | Type I | Type II | (STI) |
| Assay, % by weight, min. | 99.5 | 99.5 | 8207 |
| Total acidity as HCl, % | 0.002-0.005 | 0.007-0.009 | 8202 |
| Hydrolyzable chloride, wt. % | 0.002-0.005 | 0.008-0.012 | 8203 |
| Isomer ratio - 2, 4, wt. % | 80 ± 1 | 80 ± 1 | 8207 |
| Isomer ratio - 2, 6, wt. % | 20 ± 1 | 20 ± 1 | 8207 |
| Color, APHA maximum | 15 | 15 | 8206 |

TABLE 8
Lupranate ® T80 (Toluene Diisocyanate) - Typical Properties

| | |
|---|---|
| Molecular weight | 174.2 |
| Specific Gravity | 1.22 gm/cc, 25/25° C. |
| Boiling Point 10 mm Hg, ° F. | 248 |
| Density, @20° C., lbs/gal | 10.2 |
| Flash point, ° F., (COC) | 270 |
| Vapor pressure @20° C., mm Hg | 0.01 |
| Freezing point, ° F. | 53.6 |

TABLE 9
Voranate ® T80 (Toluene Diisocyanate)

| | Type I | Type II | |
|---|---|---|---|
| | Low Acidity | High Acidity | |
| Specification Limits | Grade | Grade | Method |
| Assay, %. | 99.5 | 99.5 | ASTM D1638-70 |
| by weight, min | | | |
| Total acidity | 0.0010-0.0040 | 0.0070-0.0120 | ASTM D1638-70 |
| as HCl, % | | | |
| Hydrolyzable | 0.0015-0.0070 | 0.0070-0.0150 | ASTM D1638-70 |
| chloride, wt. % | | | |
| Total Chloride, | 0.06 | 0.07 | ASTM D1638-70 |
| wt. % max. | | | |
| Isomer ratio - | 79-81 | 79-81 | ASTM D1638-70 |
| 2, 4, wt. % | | | |
| Isomer ratio - | 19-21 | 19-21 | ASTM D1638-70 |
| 2, 6, wt. % | | | |
| Color, | 25 | 25 | ASTM D1638-70 |
| APHA maximum | | | |

TABLE 10
Voranate ® T80 (Toluene Diisocyanate) - Typical Physical Properties

| | |
|---|---|
| Molecular Weight | 174.2 |
| Physical Form | Colorless to Pale Yellow |
| | Liquid |
| Odor | Very Sharp and Pungent |
| Density (@20° C.), lbs/gal | 10.2 |
| Specific Gravity (25° C./25° C.) | 1.22 |
| Boiling Point at 10 mmHg | 248° F. (120° C.) |
| Boiling Point at 760 mmHg | 482° F. (250° C.) |
| Viscosity @ 77° F. (25° C.) cps | 3 |
| Freezing Point | 57° F. (14° C.) |
| Flash Point-Cleveland Open Cup | 270° F. (132° C.) |
| Flash Point-Pensky-Martens Closed Cup | 260° F. (127° C.) |
| Flash Point-Tag Open Cup | 270° F. (132° C.) |
| Fire Point-Cleveland Open Cup | 295° F. (146° C.) |
| Refractive Index @77° F. (25° C.) | 1.5651 |
| Specific Heat, Btu/lb, ° F. | 0.35 @ 68° F. |
| | 0.41 @ 212° F. |
| Heat of Evaporation @ 250° F. (121° C.) | 131 Btu/lb (73 cal/g) |
| Heat of Evaporation @ 355° F. (197° C.) | 121 Btu/lb (67 cal/g) |
| Decomposition Temperature | 530° F. (287° C.), |
| Vapor Density (Air = 1) | 6.0 |
| Vapor Pressure @ 77° F. (25° C.), mmHg | 0.01 |

The blowing agent may be any suitable blowing agent, for example water. Physical blowing agents such as carbon dioxide, acetone, pentane, nucleating gas such as air or nitrogen, or combinations thereof may also be used.

The catalyst may be any suitable catalyst for use in a reaction to form polyurethane foam, and in an embodiment the catalyst is an organotin catalyst. Organotin catalysts are a family of organic tin compounds used as catalysts in flexible polyurethane foam production that help to control the gelation reaction rate, for example, when the blend becomes a gel. The catalyst reacts into the foam product and serves as a cell wall reinforcer so the final foam material will stand up and not collapse. Examples of organotin catalysts include stannous octoate, dibutyltin dilaurate, dibutyltin diacetate, and dibutyltin diethyl hexoate. In an embodiment stannous octoate is generally used as the organotin catalyst when producing conventional foams. In an alternate embodiment dibutyltin dilaurate is used as the organotin catalyst when producing HR foams. In an alternate embodiment, the catalyst is an amine catalyst. These catalysts include amines that balance the gelation and blowing reactions, examples of which include NLIX A-130, NIAX A-1, NIAX A-300, NIAX A-130 by OSI Specialties, a division of Compton Corporation.

Additional components suitable for incorporation into polyurethane foam may be added such as activators, stabilizers, amines, colorants, dyes, pigments, chain-extending agents, surface-active agents (i.e., surfactants), fillers, and the like. As will be readily apparent to one of skill in the art, a wide variety of polyurethane foam formulations incorporating an equally wide variety of components such as polyols and isocyanates may be produced according to the present invention.

Various processes may be employed for making the foam of the present invention. In an embodiment a process of making the foam of the present disclosure is a slab stock process. In an alternate embodiment a carbon dioxide frothing process is utilized. Both of these processes will be discussed in detail after the following discussion of the process for blending of the chemicals which is the first step in either foam production process.

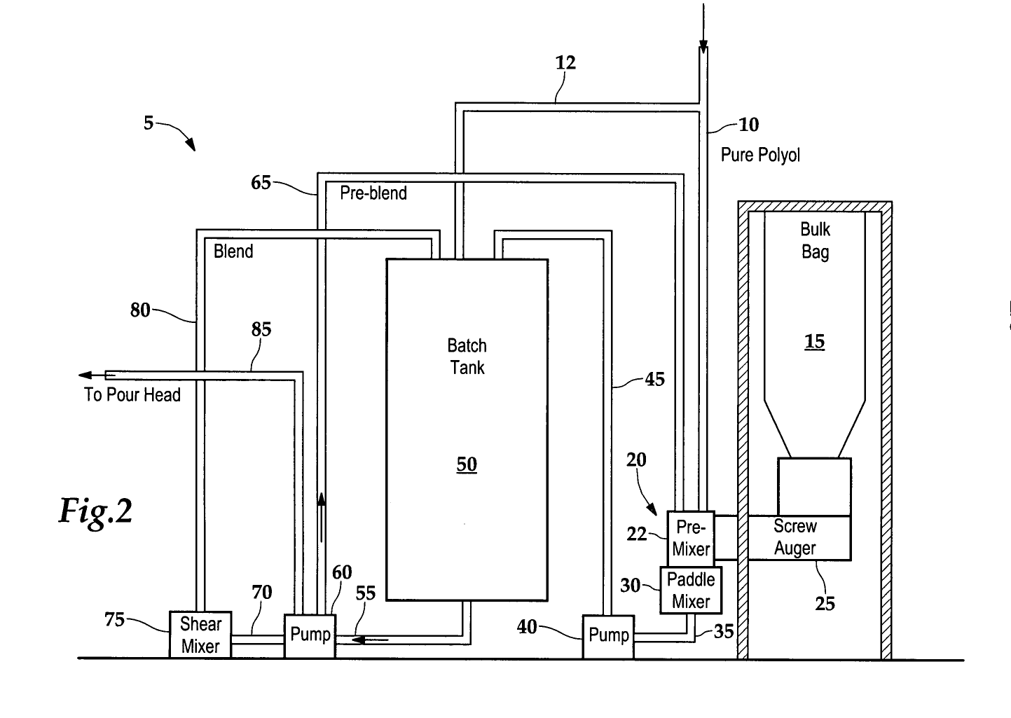

Melamine is blended with a polyol via high shear to form a blend. In an embodiment shown in FIG. 2, the polyol and melamine are blended in a high shear blending unit 5 configured for receiving and blending polyol and melamine and discharging a blend into a transfer line. In an embodiment, the melamine and polyol are added in a two step process wherein in a first step a pre-blend of melamine and polyol is formed and in a second step the pre-blend is subjected to high shear to form a final blend. In an alternative embodiment, the pre-blending and shearing are performed simultaneously.

Referring to FIG. 2, polyol in stream 10 is combined with melamine from a bulk bag 15 into pre mixer 20. Any suitable means may be used for transporting and conveying the melamine, and in the embodiment of FIG. 2 the melamine is gravity fed from the bulk bag 15 (such as a 2000 lb. “super-sack”) to a screw auger 25 and into pre-mixer 20. The pre-mixer may further comprise a loading trough or chute 22 positioned above a paddle mixed retention tub 30. Melamine and polyol enter the loading chute and fall by gravity into the retention tub, where they are mixed by the pre-mixer to form a melamine-polyol pre-blend wherein the melamine is suspended in the polyol. The melamine-polyol pre-blend flows via stream 35 to pump 40 where it is pumped via stream 45 to agitated batch tank 50, where the pre-blend is agitated to ensure that the melamine remains suspended in the polyol. In an embodiment, a paddle wheel mixer rotating at about 7 rpm provides agitation. The melamine-polyol pre-blend flows via stream 55 to pump 60 where it is pumped via stream 65 back to pre-mixer 20 where additional polyol and/or melamine are added to the pre-blend until the pre-blend is acceptable. The flow rates of material into and out of pre-mixer 20 are balanced such that the pre-mixer does not overflow. A preferred pre-blend is a 1:1 ratio of melamine to polyol having a viscosity of about 3600 cps at 75° F. and having no visible lumps or agglomerations upon visual inspection. If needed, the pre-blend may be recirculated via stream 65 for further mixing in pre-mixer 20 to remove visible lumps and/or agglomerations. Once the pre-blend is acceptable, pumps 40 and 60 are stopped, and the pre-blend is held in agitated batch tank 50.

In another embodiment, an amount of polyol required to mix with a predetermined amount of melamine (e.g., a 2000 lb. super-sack) is charged directly into the batch tank 50 via stream 12 (rather than to pre-mixer 20 via stream 10) and recirculated to pre-mixer 20 as described previously where the melamine is added at a rate of about 50 lbs/min. during recirculation to form the pre-blend. Recirculation continues until all the melamine in the super-sack has been added and the pre-blend is acceptable, as described previously. In another embodiment, polyol may be added to the batch tank via stream 12 and the pre-mixer 20 via stream 10 either simultaneously or in sequence.

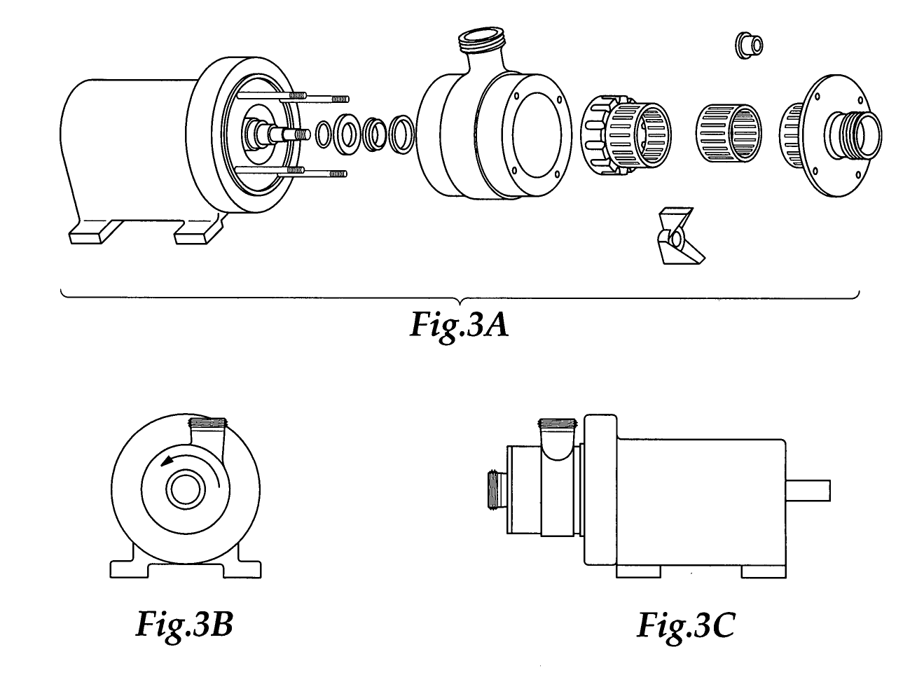

The pre-blend is pumped by pump 60 via stream 70 to high shear mixer 75 where the melamine and polyol undergo high shear blending to form the final blend (referred to herein simply as the “blend”). High shear blending (sometimes referred to as high shear mixing) is a term of art within the mixing industry, and is used as such herein. In terms of mechanism, shear blending is sometimes referred to as a tangential stress caused by the fluid viscosity pushing in parallel against another material surface in a tangential direction of local motion. In an embodiment, the high shear mixer 75 is an in-line shear pump model No. SP4 available from Waukesha Cherry-Burrell, shown in FIGS. 3A and 3B. In the Waukesha mixer, the components to be mixed enter the mixer through a stationary cover stator inlet port and proceed into a counterclockwise rotating inner rotor where they are forced through inner rotor openings and meet stationary cover stator openings. The components are forced outward through these slotted openings into counterclockwise rotating outer rotor openings before exiting through a body discharge port. Other mixers providing equivalent, high shear mixing may be employed in the process. From the high shear mixer, the blend is returned to agitated batch tank 50 via stream 80. The blend in batch tank 50 is recirculated through shear mixer 75 until the blend has no visible signs of agglomerations, coagulations, or lumps of particles in solution, which can be seen by placing a few drops of the blend solution onto a plate glass and drawing the sample down into a thin layer for observation. In an embodiment, the blend is recirculated for a minimum of about 2 hours at 300 lbs/hr flow rate and a blend temperature of about 21° C. A preferred blend is a homogeneous blend comprising a 1:1 ratio of melamine to polyol, which is mixed to form a suspension of non-settling particles within the medium (polyol). The melamine-polyol suspension desirably is subjected to constant agitation to allow for the uniform distribution of aggregate molecules of melamine in solution and to ensure that the melamine particles do not settle out over time.

The blend is held in agitated batch tank 50 until needed for a polyurethane foam production run, at which time the blend is conveyed via pump 60 and transfer line 85 for further processing as described herein. In an embodiment, the blend is maintained at a temperature of 21° C. in the agitated blend tank 50. Isocyanate, water, catalyst, and optionally other additives are added to the blend, and the blend is laid down to form polyurethane foam. In an alternate embodiment, the blend may be filtered prior to lay down to remove any melamine agglomerations.

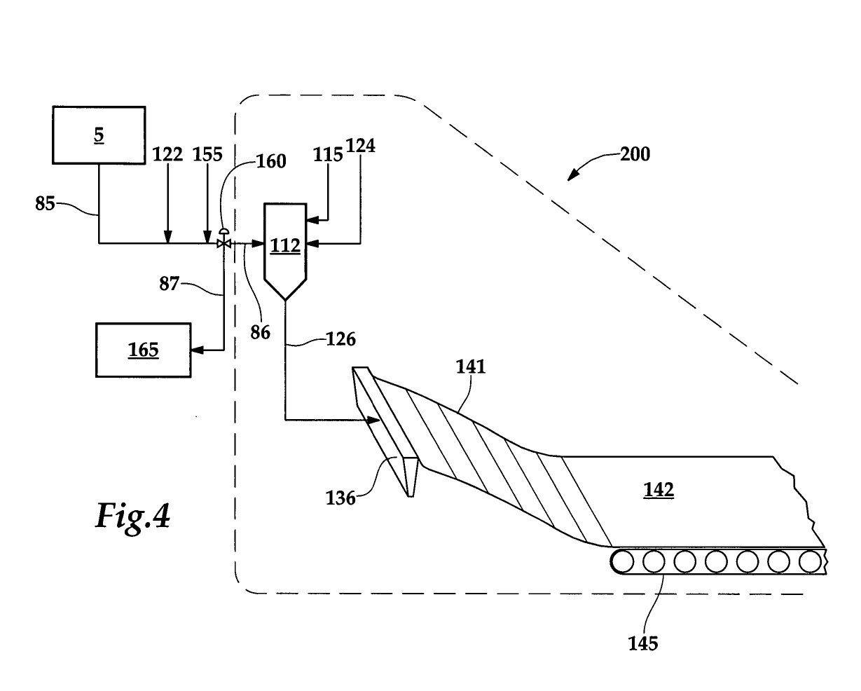

FIG. 4 illustrates a slab stock process for making polyurethane foam. Referring to FIG. 4, the blend as described above, is conveyed from the high shear blending unit 5 via transfer line 85 to a polyurethane foam production line. Water may be added to the blend via stream 122. In an embodiment one or more additional flame-retardant compounds (in addition to melamine) can be added to the blend via stream 155 as shown in the embodiment in FIG. 4. The blend then proceeds to a diverter valve 160. At valve 160 the blend could be diverted to a carbon dioxide frothing process 165 (as described in detail below) via stream 87 if that is the desired process. Otherwise, the blend is sent to a slab stock process 200 via stream 86.

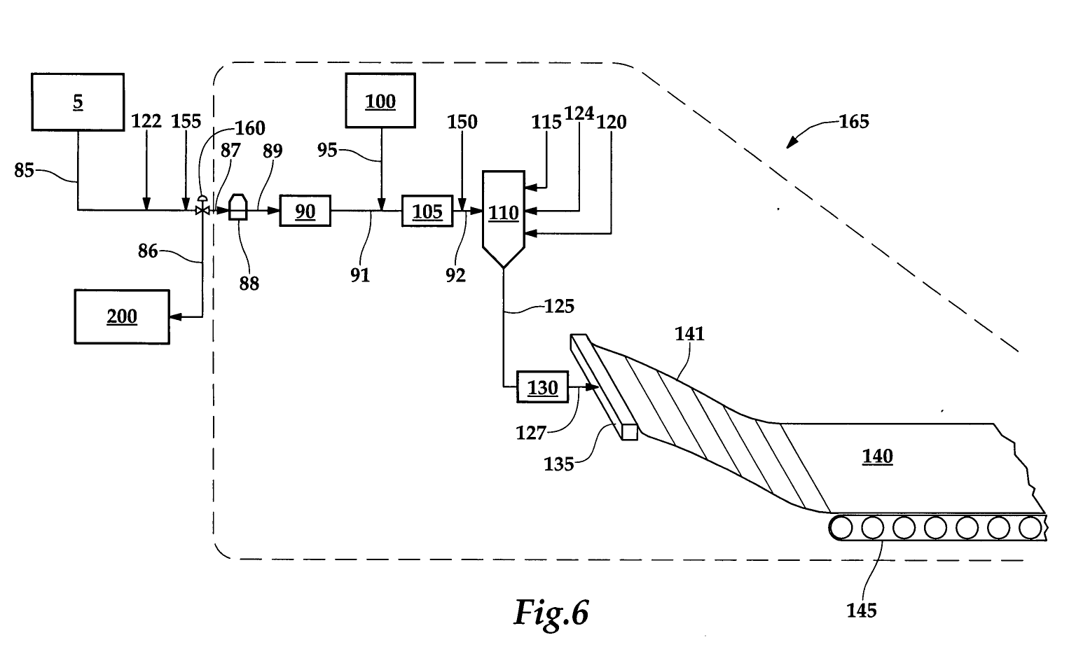

Production process selection may depend on the foam product desired, for example, the desired density and hardness (IFDs) of the foam. Table 13 is a list of ranges of physical properties for the combustion modified foams according to the production process and will be discussed in more detail later. If the desired foam density and IFD is within the range limits of production specifications for the slab stock process 200, as shown in Table 13, the valve may be set to allow flow of the blend to the slab stock process 200. If a softer, less dense product is desired that falls within the range limits of production specifications for the carbon dioxide frothing process 165, as shown in FIG. 6, the valve may be set to allow flow of the blend to the carbon dioxide frothing process 165. Specification ranges can overlap for the combustion modified foams according to the production process. Accordingly, other factors may be involved in determining the production process.

As shown in FIG. 4 for the slab stock process 200, the blend is conveyed into a low pressure mixing head 112 that is connected to stream 86. The mixing head 112 is configured for receiving the blend, receiving and mixing isocyanate via stream 115 and catalyst via stream 124 into the blend, and discharging the blend. An example of a suitable mixing head is a 1.75 liter capacity, low pressure mixing head equipped with stator pins and a variable speed, pinned stirrer, available from Cannon-Viking Ltd. The pressure range inside the mix head is about 7 to about 25 psig. The line pressure leading into the mix head is about 7 to about 25 psig and the line pressure downstream of the mix head is about 1 to about 5 psig. Upon addition of the isocyanate and tin to the blend comprising melamine, polyol and water, the mixture becomes “active” in that the well-known chemical reaction forming polyurethane foam is initiated.

The blend is conveyed via stream 126 into a lay down device 136 configured for receiving the discharged blend and laying down the active blend or “froth” to form polyurethane foam. In an embodiment, the lay down device is a metal trough, where the feed enters near the bottom of the trough and the initial reaction begins to take place. Residence time in the trough of about 18 to 21 seconds allows the blend to react and transform from a very liquid state into a creamy, frothy state. The trough continues to fill with reacting blend to the point at which it overflows on to a bottom support layer (not shown), such as a plastic film liner, which is sliding on an inclined fall plate 141. The fall plate 141 can be adapted to a length and configuration so that the foam will reach a horizontal conveyor 145 as a fully expanded foam slab. The conveyor carries the reacting blend away from the trough at a rate of about 11 to 22 feet per minute. At about 20 to 25 feet from the trough, the foam is fully expanded and gases generated during the reaction have escaped through the surface of the slab. An elapsed time of about 60 to 150 seconds is typically required to reach the point where the froth fully expands to form a solid sheet of polyurethane foam 142, which is conveyed by conveyor 145 for further processing. It continues along the conveyor until it reaches a cut-off saw (not shown) where about 60 feet blocks or buns are cut from the continuous slab. The reaction utilized in the production of polyurethane foam is exothermic so the warm buns are allowed to cool and cure prior to stacking and storing. In an embodiment the buns can be cured by a rapid cure system (not shown) in about 10 to 15 minutes to cool the internal bun temperature from about 360° F. to about 140° F. In this embodiment, after the polyurethane foam is cut, the bun can then be transported by overhead cranes and set on a vacuum table which then pulls about 10,000 CFU of ambient air through the bun, with emissions being sent to carbon scrubbers. Once cooled, the buns can again be transported by overhead cranes and safely stacked in a storage area.

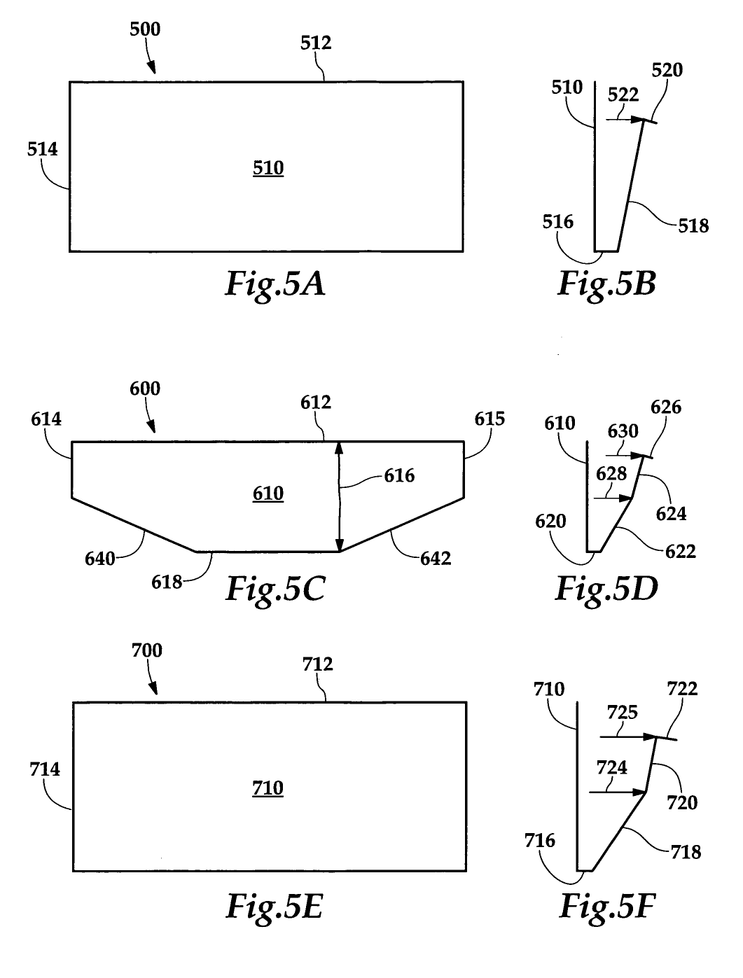

Depending on the product desired, the throughput of chemicals in the slab stock process 200 can range from about 230 to 350 liters/minute. Accordingly, various sizes of troughs can be utilized to accommodate the process, changing out the trough prior to production startup. FIG. 5 is a diagram depicting the various metal troughs, illustrating the trough dimensions for troughs 500, 600, and 700 by showing both a back view and an end view of each trough. In FIG. 5, trough 500 has a width along side 512 of about 82 inches and a height along side 514 of about 24.5 inches forming a vertical rectangular shaped side 510 of the trough through which the blend is received and about 18.5 vertical inches on the angled spillover side 518 of the trough, that is the side where the blend spills over onto the inclined fall plate 141 (as shown in FIG. 4). The cross-thickness of the trough between the two sides is about 3 inches at the bottom 516 and about 5.5 inches at the top 522 where the spillover occurs. There is an about 1.5-inch extension 520 towards the fall plate along the top lip of the angled spillover side 518 of the trough. In an alternate embodiment, trough 600 has a width along side 612 of about 75 inches at the top and about 35 inches at the bottom along side 618. A v-shape is formed in the lower portion of the back view of trough 600 along sides 640 and 642 from the bottom 618 up to the bottom of sides 614 and 615, at a point about 13 inches from the top. The width is the same at all points between sides 614 and 615 forming a rectangular shape in the upper portion of the back view of trough 600. The trough 600 has a total vertical height 616 of about 18.5 inches on the side through which the blend is received 610 and about 14 vertical inches on the spillover side of the trough, angled sides 622 and 624. The cross-thickness of the trough is about 2 inches at the bottom 620, angled to about 7 inches thick at point 628 that is about 6 inches up and angled to about 9.25 inches thick 630 at the top where the spill-over occurs. There is an about 2.5-inch extension 626 towards the fall plate along the top of the spillover side of the trough. In another alternate embodiment, trough 700 has a width along side 712 of about 65 inches and a height along side 714 of about 19 inches forming a vertical rectangular shaped side 710 of the trough through which the blend is received. Trough 700 is about 13 vertical inches on the angled spillover sides 718 and 720 of the trough. The cross-thickness of the trough is about 1 inch at the bottom 716, angled to about 7 inches at a point 724 that is about 6 inches up and angled to about 9 inches at the top 725 where the spill-over occurs. There is an about 3-inch extension 722 towards the fall plate along the top of the spillover side of the trough.

Additional components suitable for incorporation into polyurethane foam may be added at various locations in the process in other embodiments. Other commonly known additives for polyurethane foam such as activators, catalysts, stabilizers, colorants, dyes, pigments, chain-extending agents, surface-active agents (i.e., surfactants), fillers, blowing agents, and the like may be added at appropriate locations in the process, as will be known to those of skill in the art. As will be readily apparent to one of skill in the art, a wide variety of polyurethane foam formulations incorporating an equally wide variety of components such as polyols and isocyanates may be produced according to the present invention.

FIG. 6 illustrates a carbon dioxide frothing process for making polyurethane foam. Referring to FIG. 6, the blend is conveyed from the high shear blending unit 5 via transfer line 85 to a polyurethane foam production line. One or more additional flame-retardant compounds (in addition to melamine) can be added to the blend via stream 155 as shown in the embodiment in FIG. 6. Again, as was mentioned for the slab stock process, additional components suitable for incorporation into polyurethane foam may be added in other embodiments at appropriate locations in the process. For example, a nucleating gas such as nitrogen or air may be added to the blend via stream 150, which is added upstream of a mixing head 110 shown in an embodiment in FIG. 6.

The blend proceeds to a diverter valve 160 that has been set to divert flow to the carbon dioxide frothing process 165 via stream 87. The blend proceeds to a pressure-boosting pump 88 where the pressure of the blend is increased from about 50 psig to about 900 psig. The blend then enters a first filter 90 via stream 89 wherein the blend is filtered to remove any melamine agglomerations that may be present. In an embodiment, the filter comprises a filtering screen having a hole size of about 300 microns, meaning that agglomerations of size greater than about 300 microns are trapped on the filter screen and removed from the blend. An example of a suitable filter is a type P1-7362-1551-50100 available from Mahle Industrial Filter. In an embodiment, the filter is scraped to remove accumulated agglomerations thereon, and such scraping may be performed manually or by a motorized scraping means connected to the filter.

Carbon dioxide injection unit 100 adds liquefied carbon dioxide via stream 95 into the blend in stream 91. The liquid carbon dioxide mixes or “dissolves” into the blend under high pressure and remains in solution until the blend is laid down to form a foam, at which time the pressure is reduced and the carbon dioxide is released from solution in the form of gas bubbles that act as a physical blowing agent to expand the reacting cells of the polyurethane foam froth. In an embodiment, carbon dioxide is injected at about 900 psig and about −14° C. Carbon dioxide injection units are commercially available, for example the CarDio™ process available from Cannon Viking Ltd. of Manchester, U.K. Other suitable carbon dioxide injection systems are available from Beamech Group Ltd. and Hennecke GmbH. Examples of carbon dioxide injection frothing systems are shown in U.S. Pat. Nos. 5,639,483; 5,665,287; 5,629,027; 5,620,710; 5,578,655; RE37,115; RE37,012; RE37,075; European publications EP0770466A2; EP0786286A1; EP0645226A2; and EP0786321A1; and WIPO/PCT publication WO98/23429, each of which is incorporated by reference herein in its entirety. In the embodiment shown in FIG. 6, the carbon dioxide is injected after the blend is filtered in filter 90 (i.e., injected downstream of filter 90).

After carbon dioxide is injected into the blend, the blend is subjected to further mixing to ensure that the blend is thoroughly mixed, for example by placing one or more static mixers 105 in the transfer line 91 downstream of the carbon dioxide injection point. The blend is conveyed into a mixing head 110 connected to transfer line 92. The mixing head 100 is configured for receiving the blend, receiving and mixing isocyanate via stream 115, water via stream 120, and catalyst via stream 124 into the blend, and discharging the blend. In an alternate embodiment, the water could be added upstream of the mixing head via stream 122 as was shown in the slab stock process 200 in FIG. 4. An example of a suitable mixing head is a Cannon-Viking Ltd. Product No. MK-IV, 2.8 liter capacity, high pressure mixing head equipped with stator pins and a variable speed, pinned stirrer. The pressure range inside the mix head is about 147 to about 300 psig. The line pressure leading into the mix head is about 550 to about 900 psig and the line pressure downstream of the mix head is about 110 to about 300 psig. Upon addition of the isocyanate and water, the blend becomes “active” in that the well-known chemical reaction forming polyurethane foam begins.

The blend is discharged from the mixing head via stream 125 to a second filter 130 wherein the blend is filtered to remove any melamine agglomerations that may be present. In an embodiment, the filter comprises a filtering screen having a hole size of about equal to or less than the slot width in the gate bar (as described below), meaning that agglomerations of a size greater than about the width of the gate bar slot are trapped on the filter screen and removed from the blend such that the gate bar slot is not plugged. In an embodiment, the filter has a screen size of about 380 microns, which also corresponds to about the gate bar slot width. In another embodiment, the filter has a screen size of about 436 microns, which also corresponds to about the gate bar slot width. An example of a suitable second filter is type No. 105776 available from Cannon-Viking Ltd.

The blend is conveyed via stream 127 into a lay down device 135 configured for receiving the discharged blend and laying down the active blend or “froth” to form polyurethane foam. In an embodiment, the lay down device is a gate bar, which is a rectangular bar having internal distribution channel for distributing the blend along the width of the bar and a narrow discharge slot running the width of the bar. The width of the discharge slot can be adjusted using shims. In an embodiment, the gate bar has a width of about 1.8 meters or about 2.0 meters, with a discharge slot about 380 microns or about 432 microns wide running substantially the entire width of the gate bar. The froth is discharged out the slot along the width of the bar where the froth then slides down the inclined fall plate 141 as was described previously for the slab stock process 200. The froth expands to form a sheet of polyurethane foam 140, which is conveyed by conveyor 145 for further processing. The remaining processing steps may be the same as those described previously for the slab stock process.

### EXAMPLES

TABLE 11
Foam Formula A

| | PHD |
|---|---|
| CHEMICALS | |
| POLYOL-VORANOL 3136 | 99.0000 |
| TDI-VORANATE T-80 | 59.5600 |
| MELAMINE | 10.0000 |
| FIRE RETARDANT-DE60F SPECIAL | 15.5000 |
| TIN-KOZMOS-29 | 0.2000 |
| AMINE-NIAX A-1 | 0.0167 |
| AMINE-NIAX A-33 | 0.0500 |
| SILI CONE-L-620 | 0.7500 |
| WATER | 4.5000 |
| POLYOL-DP-1022 | 1.0000 |
| REACTINT BLUE X-3 | 0.0180 |
| REACTINT VIOLET X-80 | 0.0090 |
| AMINE-NIAX A-127 | 0.2500 |
| PHYSICAL PROPERTIES | |
| Density, PCF | 1.55 |
| 25% IFD, lb/50 in² | 31.30 |
| Air flow | 2.60 |
| FLAMMABILITY | |
| California T.B. 117 Open Flame | 2.95 pass |
| Char length (6 inch average) | |
| California T.B. 117 Smolder, wt. % | 99.30 pass |
| (80% Min) | |

TABLE 12
Foam Formula B

| | PHD |
|---|---|
| CHEMICALS | |
| POLYOL-PLURACOL P-1385 | 100.0000 |
| TDI-VORANATE T-80 | 61.8000 |
| MELAMINE | 10.0000 |
| FIRE RETARDANT-DE60F SPECIAL | 16.5000 |
| TIN-KOZMOS-29 | 0.2250 |
| AMINE-NIAX A-1 | 0.0217 |
| AMINE-NIAX A-33 | 0.0650 |
| SILI CONE-B-8250 | 1.5800 |
| WATER | 5.1500 |
| CO2 (auxiliary blowing agent) | 2.8000 |
| REACTINT BLUE X-3 | 0.2100 |
| REACTINT VIOLET X-80 | 0.0450 |
| PHYSICAL PROPERTIES | |
| Density, PCF | 1.1300 |
| 25% IFD, lb/50 in² | 20.0000 |
| Air | 2.6000 |
| FLAMMABILITY | |
| California T.B. 117 Open Flame | 2.45 pass |
| Char length (6 inch average) | |
| California T.B. 117 Smolder, wt. % | 96.90 pass |
| (80% Minimum) | |

Tables 11 and 12 above represent formulation sheets for two foams identified as Foam A and Foam B where the unit, PHD, is the abbreviation for parts per hundred. The tables above also list the physical properties and flammability test results for foams A and B. The foam sample identified as foam A in Table 11 represents a typical foam formulation for the combustion modified polyurethane foam of this disclosure and was produced according to the slab stock process 200 as described earlier in this document. The physical properties of density and indentation force deflection (IFD) were determined according to ASTM D3574-95. IFD is a measure of the load bearing capacity of flexible polyurethane foam and is sometimes referred to as the ‘hardness’ of the foam. The percent airflow was determined by measuring the pressure drop across the foam sample and correlating the pressure drop to cubic feet of air per minute. Pressure drop may be measured, for example, using a Magnahelic gauge. The flammability performance was determined according to the California 117 Burn Test, part I, which is a vertical flame test using an open flame, and part II, which is a smoldering cigarette test. Test results for Foam A show that it has a density of 1.55 pcf (pounds per cubic foot) and an IFD of 31.3 lb/50 in², both within the desired product range limits as outlined earlier in the detailed description. Foam A passed both parts of the California 117 Burn Test with very good results of 2.95 inches of char length in the open flame test where an average of 6 inches, with none greater than 8 inches, is required to pass, and 99.3% weight percent in the smolder test, where a minimum of 80% is required to pass.

The foam sample identified as foam B in Table 12 above represents a typical foam formulation for the combustion modified polyurethane foam of this disclosure and was produced according to the carbon dioxide frothing process 165 as described earlier in this document. Again, the physical properties of density and indentation force deflection were determined according to ASTM D3574-95, the percent air flow was determined as described above, and the flammability performance was determined according to the California 117 Burn Test. Test results for Foam B indicate that it has a density of 1.13 pcf and an IFD of 20 lb/50 in², both within the desired product range limits as outlined earlier in the detailed description. Also, Foam B passed both parts of the California 117 Burn Test, with very good results of 2.45 inches of char length in the open flame test, and 99.3% weight percent in the smolder test.

TABLE 13
Physical Property Ranges for Combustion Modified
Polyurethane Foam Products

| Location of | | Range of Densities | Range of IFDs |
|---|---|---|---|
| Equipment | Process | (PCF) | (lb/50 in²) |
| Site A | Slab Stock Process | 1.30 TO 2.60 | 23 TO 150 |
| | (non-CO₂) | | |
| Site A | CO₂ Frothing | 0.90 TO 1.45 | 12 TO 41 |
| Site A | Either | 1.35 TO 1.45 | 17 TO 31 |
| Site B | Slab Stock Process | 1.20 TO 2.90 | 20 TO 95 |
| | (non-CO₂) | | |
| Site B | CO2 Frothing | 0.85 TO 1.35 | 13 TO 33 |
| Site B | Either | 1.20 TO 1.30 | 30 TO 36 |

Table 13 above is a list of physical property ranges for combustion modified polyurethane foam products made according to compositions and methods of this disclosure. Product densities and indentation force deflections are listed representing the overall ranges for various foam formulations made by the carbon dioxide frothing process, the slab stock process, or either process at two different manufacturing sites, A and B. Generally, the density and IFD values tend to be lower for the carbon dioxide frothing process products versus the slab stock process products. Also, the range of the densities and IFDs tends to be narrower for the carbon dioxide frothing process products than the slab stock process products. In each case listed in Table 13, the range for density and IFD falls within the desired product range limits as outlined earlier in the detailed description. In an embodiment, denser foam products are generally produced according to the slab stock process 200 to achieve desired higher ranges of densities.

According to the chemical composition and processes described in this disclosure, incorporation of melamine into flexible polyurethane foam as a flame retardant can be made using low amounts of a second flame retardant compound producing a product that meets desired physical property specifications as well as passes the California T.B. 117 burn test. Less of the additional flame retardant compound in the combustion modified foam is generally required when used in combination with the melamine, and consequently formulation costs are reduced. The chemical composition as detailed earlier may benefit from the synergistic effect when the melamine and the second flame retardant compound are combined. As discussed in the detailed description, the combustion modified polyurethane foam composition can be manufactured using procedures such as a slab stock process and a carbon dioxide frothing process.

While the preferred embodiments of the invention have been shown and described, modifications thereof can be made by one skilled in the art without departing from the spirit and teachings of the invention. Foam formulations and process equipment design criteria and operating conditions (where not specifically defined) for any given implementation of the invention will be readily ascertainable to one of skill in the art based upon the disclosure herein. The embodiments described herein are example of a suitable only, and are not intended to be limiting. Many variations and modifications of the invention disclosed herein are possible and are within the scope of the invention.

1. A polyurethane foam comprising less than about 10 weight percent melamine based on the total weight of the foam and less than about 10 weight percent of one or more additional flame retardant compounds based on the total weight of the foam.

2. The foam of claim 1 wherein the foam passes the California 117 Burn Test.

3. The foam of claim 1 wherein the foam is a reaction product of one or more polyols, one or more isocyanates, one or more blowing agents, and one or more catalysts.

4. The foam of claim 1 wherein the melamine comprises less than about 8.5 weight percent based on the total weight of the foam.

5. The foam of claim 1 wherein the melamine comprises from about 5 to about 6 weight percent based on the total weight of the foam.

6. The foam of claim 1 wherein the additional flame retardant compounds comprise less than about 8 weight percent based on the total weight of the foam.

7. The foam of claim 4 wherein the additional flame retardant compounds comprise less than about 8 weight percent based on the total weight of the foam.

8. The foam of claim 1 wherein the additional flame retardant compounds comprise less than about 6 weight percent based on the total weight of the foam.

9. The foam of claim 5 wherein the additional flame retardant compounds comprise less than about 6 weight percent based on the total weight of the foam.

10. The foam of claim 1 wherein the weight ratio of melamine to the additional flame retardant compounds is in the range of from about 0.5 to about 2.0.

11. The foam of claim 1 wherein the weight ratio of melamine to the additional flame retardant compounds is in the range of from about 0.6 to about 1.5.

12. The foam of claim 1 wherein the weight ratio of melamine to the additional flame retardant compounds is in the range of from about 0.75 to about 1.25.

13. The foam of claim 1 wherein the weight ratio of melamine to the additional flame retardant compounds is about 1.

14. The foam of claim 3 wherein the reaction product comprises about 100 parts per hundred of the polyol.

15. The foam of claim 1 having a density of within the range of from about 0.9 to about 4.25 lb/ft³, a 25% IFD in the range of from about 7 to about 150 lb/50 in², and an air flow in the range of about 2.0 to about 5.5 ft³/minute.

16. The foam of claim 1 having a density of within the range of from about 0.9 to about 1.5 lb/ft, a 25% IFD in the range of from about 7 to about 54 lb/50 in², and an air flow in the range of about 4.0 to about 5.5 ft³/minute.

17. The foam of claim 1 having a density of within the range of from about 1.6 to about 4.25 lb/ft³, a 25% IFD in the range of from about 11 to about 150 lb/50 in², and an air flow in the range of about 2.0 to about 4.0 ft³/minute.

18. The foam of claim 1 wherein the melamine is ground melamine.

19. The foam of claim 18 wherein the ground melamine has a volume average particle size distribution of 100%<=about 74 microns, 75%<=about 19.25 microns, 50%<=about 12.28 microns, 25%<=about 6.84 microns, 0%<=about 0.83 microns.

20. The foam of claim 1 wherein the additional flame retardant compound is a pentabromodiphenyl oxide blend halogenated flame retardant.

21. The foam of claim 1 wherein the additional flame retardant compound is phosphorus-bromine.

22. A slab stock process for making a polyurethane foam comprising adding less than about 10 weight percent melamine based on the total weight of the foam and less than about 10 weight percent of one or more additional flame retardant compounds based on the total weight of the foam.

23. The process of claim 22 wherein the melamine is ground melamine.

24. The process of claim 23 further comprising pre-blending the ground melamine with a polyol under high shear prior to foaming.

25. The process of claim 24 wherein the pre-blend is about a 1:1 weight ratio of melamine to polyol with a viscosity of about 3600 cps at 75° F. and with no visible agglomerations.

26. The process of claim 24 wherein the high shear is applied via an in-line shear pump.

27. The process of claim 26 wherein the pre-blend is recirculated through the shear pump for a minimum of about 2 hours at about 300 lbs/hr flow rate and temperature of about 21° C.

28. The process of claim 24 further comprising agitating the pre-blend to maintain the melamine suspension therein prior to foaming.

29. A carbon dioxide frothing process for making a polyurethane foam composition comprising adding less than about 10 weight percent melamine based on the total weight of the foam and less than about 10 weight percent of one or more additional flame retardant compounds based on the total weight of the foam.

30. The process of claim 29 wherein the melamine is ground melamine.

31. The process of claim 30 further comprising pre-blending the ground melamine with a polyol under high shear prior to foaming.

32. The process of claim 31 wherein the pre-blend is about a 1:1 weight ratio of melamine to polyol with a viscosity of about 3600 cps at 75° F. and with no visible agglomerations.

33. The process of claim 31 wherein the high shear is applied via an in-line shear pump.

34. The process of claim 33 wherein the pre-blend is recirculated through the shear pump for a minimum of about 2 hours at about 300 lbs/hr flow rate and temperature of about 21° C.

35. The process of claim 31 further comprising agitating the pre-blend to maintain the melamine suspension therein prior to foaming.

36. The process of claim 31 further comprising filtering the pre-blend prior to entry into a mixing head.

37. The process of claim 36 wherein the filter has a hole size of about 300 microns.

38. The process of claim 31 further comprising filtering the foam composition after exiting a mixing head.

39. The process of claim 36 further comprising filtering the foam composition after exiting the mixing head.

40. The process of claim 39 wherein the filter has a hole size about less than or equal to the width of the discharge slot on a gate bar for laying down the foam composition.
